(19) United States
(12) Patent Application Publication
(10) Pub. No.: US 2007/0143370 A1
(43) Pub. Date: Jun. 21, 2007

(54) TVA metadata automatic generation service for home networks

(75) Inventors: Dennis Bushmitch, Somerset, NJ (US); Hong Heather Yu, Princeton Junction, NJ (US); Rajesh Khandelwal, Bridgewater, NJ (US)

Correspondence Address: GREGORY A. STOBBS, 5445 CORPORATE DRIVE, SUITE 400, TROY, MI, 48098, US

(73) Assignee: Matsushita Electric Industrial Co., Ltd., Osaka (JP)

(21) Appl. No.: 11/312,980

(22) Filed: Dec. 20, 2005

(51) Int. Cl. G06F 17/30

(52) U.S. Cl. 707/204

(57) ABSTRACT

An automatic metadata generation service system for use in home networks includes a home network interface adapted to perceive user network activity on a home network. A metadata generation service module generates user metadata based on the user network activity. An update service module automatically updates one or more existing metadata sets on the home network with generated metadata. In other aspects, a metadata generation service system for use with a home network, includes a home network interface adapted to interact with one or more of content providers or service providers according to one or more service discovery protocols. A monitoring service module obtains an update of metadata from one or more of the providers. A metadata generation service module convert metadata of one format received via the update to metadata of another format required by the home network.

### FIELD OF THE INVENTION

The present invention generally relates to a middleware service architecture supporting metadata in a home networked device control framework, and relates in particular to a metadata automatic generation service system for use in home networks.

### BACKGROUND OF THE INVENTION

Today's home networks are places for complex interactions between users and equipment, and between users and content and service providers. Metadata services provide an important function in enabling system functionality for many of such interactions. Typically, metadata is generated by content and service providers, and is associated with some content to be processed by a user and/or user's equipment. In effect, the metadata describes the content in accordance with a predefined metadata schema that labels the content according to a settled methodology so that it can be readily organized or interpreted. Today's metadata schema include XML schemas (e.g., CDS, TVA, UPnP, Dublin Core, etc.). However, there is no automatic process of generating multiple content and user metadata based on complex interactions within a home network. The present invention fulfills this need.

### SUMMARY OF THE INVENTION

In accordance with the present invention, an automatic metadata generation service (AMDGS) system for use in home networks includes a home network interface adapted to perceive user home network content viewership and other activity. A metadata generation service module generates user metadata based on home network AV control traffic and other types of user network activity. An update service module automatically updates one or more existing metadata sets on the home network with generated metadata. In other aspects, a metadata generation service system for use with a home network includes a home network interface adapted to interact with one or more of content providers or service providers according to one or more service discovery and control protocols. A monitoring service module obtains an update of metadata from one or more of the providers via these protocols. A metadata generation service module converts metadata of one format/schema to metadata of another format/schema required by the home network.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is block diagram illustrating a metadata generation service module of the metadata service in accordance with the present invention;

FIG. 2 is a block diagram illustrating monitoring and update service modules of the metadata service in accordance with the present invention;

FIG. 3 is a block diagram illustrating a first embodiment of a metadata device in accordance with the present invention;

FIG. 4 is a block diagram illustrating a second embodiment of a metadata device in accordance with the present invention;

FIG. 5 is a flow diagram illustrating a method of operation for the metadata service in accordance with the present invention; and

FIG. 6 is a flow diagram illustrating an example of user metadata generation in accordance with the present invention.

### DETAILED DESCRIPTION OF THE PREFERRED EMBODIMENTS

The following description of the preferred embodiments is merely exemplary in nature and is in no way intended to limit the invention, its application, or uses.

The middleware service architecture of the present invention provides for automatic generation of content-related and user-related metadata based on home network activity, and also based on content and service provider event notifications. This service can be discoverable and controllable from various types of consumer equipment (e.g., Audio/Video devices) devices of XML-based home control frameworks, such as UPnP. For example, user content segmentation preferences and metadata can be generated based on the user's media playback activity, with subsequent generation of related user metadata (e.g., TVA schema-based metadata). Additional service components also allow for content/user-related metadata (including content instance location metadata, content promotional metadata, and content segmentation metadata) generation and update as a result of content and service provider subscription-based services.

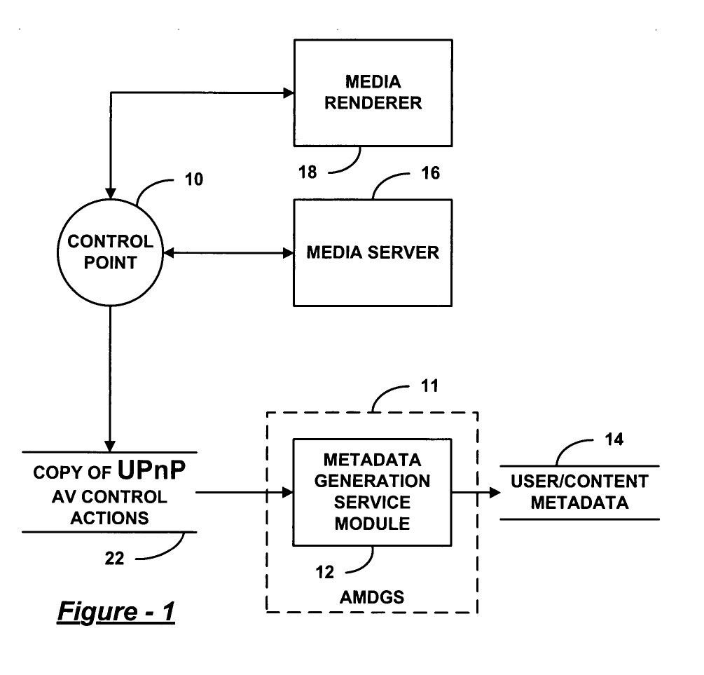

Referring to FIG. 1, automatic metadata generation service (AMDGS) 11 includes a metadata generation service module 12 that generate user metadata 14 (e.g., for TV Anytime) based on copies of UPnP audio visual control actions 22 received from a control point 10 interacting with a media server (MS) 16 and media renderer (MR) 18. User/consumer metadata relates to a user of control point 10, and user preferences are just one example of user metadata. User behaviors and viewership habits are further examples of user metadata (e.g., frequency of viewing some portion of content or preference to a specific type of content, like drama). In contrast, content metadata is related to content in a description. As an example related to UPnP eventing, consider that a user subscribes to a content promotion service (a discoverable Metadata service). User interaction with such metadata service performed through a control point 10 can result in content-related metadata being generated. If user or content metadata is affected, it can be updated based on the subscription behavior of the user.

Content could also be segmented in various ways. For example, a series can be partitioned in one hour-long segments, with commercial insertions following a pattern that is predefined by a content/service provider. This circumstance provides an example of how content can be segmented before it arrives at the home network. Content can also be segmented further by user playback activity that pauses in one place, loops, skips ahead in another, and loops back to repeat a given portion of content. It can therefore be useful to generate content segmentation metadata indicating how the content is segmented in multiple ways. For example, it can be useful to analyze streaming or stored content to determine the segments of shows and commercial insertions, and generate metadata based on the analysis. It can also be useful to record user commands relating to user consumption of the content (e.g., PLAY, PAUSE), and generate content segmentation metadata accordingly.

Generated metadata 14 can describe content consumed, rejected, or otherwise responded to by a user employing control point 10 to interface with media content. Thus, user metadata 14 can be generated based on analysis of network user activity, which can include user initiated controls, UPnP Content Directory Service (CDS)-control point (CP) activity, and/or user activity relating to control of the media server 16 and/or media renderer 18 (e.g., play/stop/fast forward).

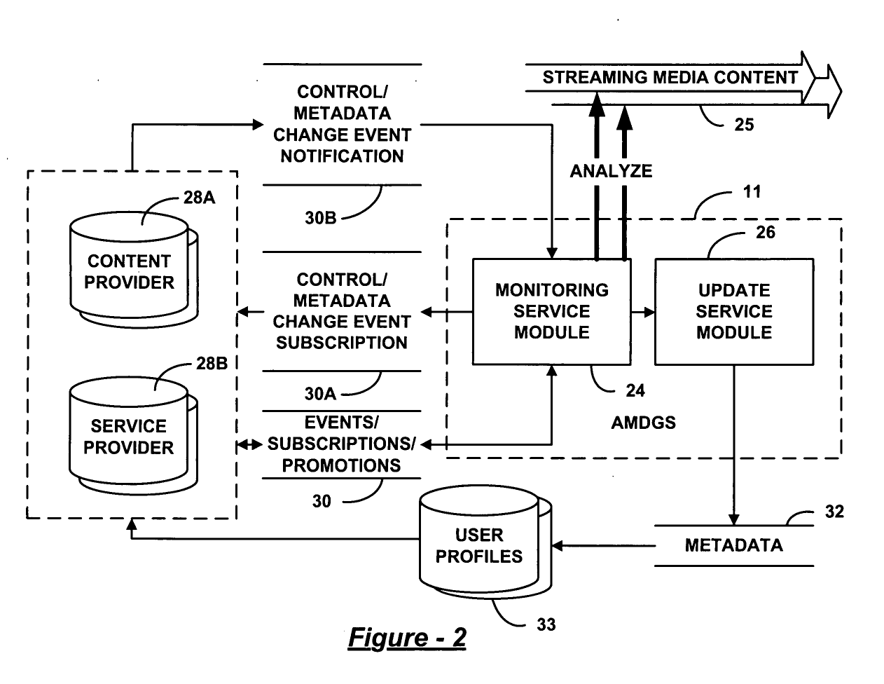

Turning now to FIG. 2, some embodiments of the AMDGS 11 according to the present invention include a monitoring service module 24 interfacing with an update service module 26. Monitoring service module 24 can monitor various forms of information 28 relating to one or more content streams and generate content and user metadata in response. For example, monitoring service module can receive streaming media content and/or related electronic programming guide (EPG) information including textual content descriptions and/or metadata from various content providers 28A and service providers 28B.

In some embodiments, monitoring service module 24 and providers 28A and 28B can cross-advertise services, exchange service-level events, event and service subscriptions, and/or promotions 30 in relation to content and services. For example, monitoring service module 24 can use a subscription message 30A to subscribe to receive an EPG update notification 30B indicating that new EPG information is available. Thus, monitoring service module 24 can periodically receive and parse EPG-related metadata and/or analyze streaming media content 25. As a result, monitoring service module 24 can generate content metadata 32 based on content stream segmentation, closed captions, subtitles, and/or vertical blanking interval contents and other types of stream analysis. In a related example, a movie can carry promotion metadata that should be utilized only after the movie is viewed. In this case, a promotional code can be delivered to the user upon watching the movie that gives the user a reference point (e.g., a new set of content location and content description metadata) to another program that is a reward to the user for purchasing and buying the original content.

It is envisioned that a service event update notification from a content provider can indicate that a series is now partitioned differently for consumer's playback, such that a serial that was previously intended to be played back in one hour segments should now be packaged for viewing in thirty minute segments. Similarly, the content can indicate a change in a pattern of commercial insertions. The automatic metadata generation service can therefore generate some of the segmentation metadata which will describe how the content in question is now segmented and/or subsequent viewership and commercial insertions are to be performed.

It should be readily understood that metadata 32 can be generated in accordance with different formats and XML schemas (e.g., CDS, TVA, UPnP, Dublin Core, etc.), and that the metadata can be used in various ways. For example, user profiles can be developed based on user network activity and follow CC/PP-based device/user profile schemas. In one example, a MD record can reflect that a particular user skipped one commercial, but watched another twice, and this MD record may be reported to content and/or service providers 28A and 28B. In another example, a child's viewing activity can be recorded and tabulated to reflect the child's habits of viewing violent content for viewing by a parent user granted access to the child's user profile by virtue of the parent user's status as the home network administrator. In still another example, a user's viewing preferences can be recorded and communicated to a device being employed by that user to view content, and the device can deliver the content according to the preferences (i.e., initial viewership format aspect, format change between normal and HDTV programs, initial volume, volume change during commercials, etc.). It is also envisioned that such metadata can be used to recommend and/or automatically record content for users using DVR type device, as an example.

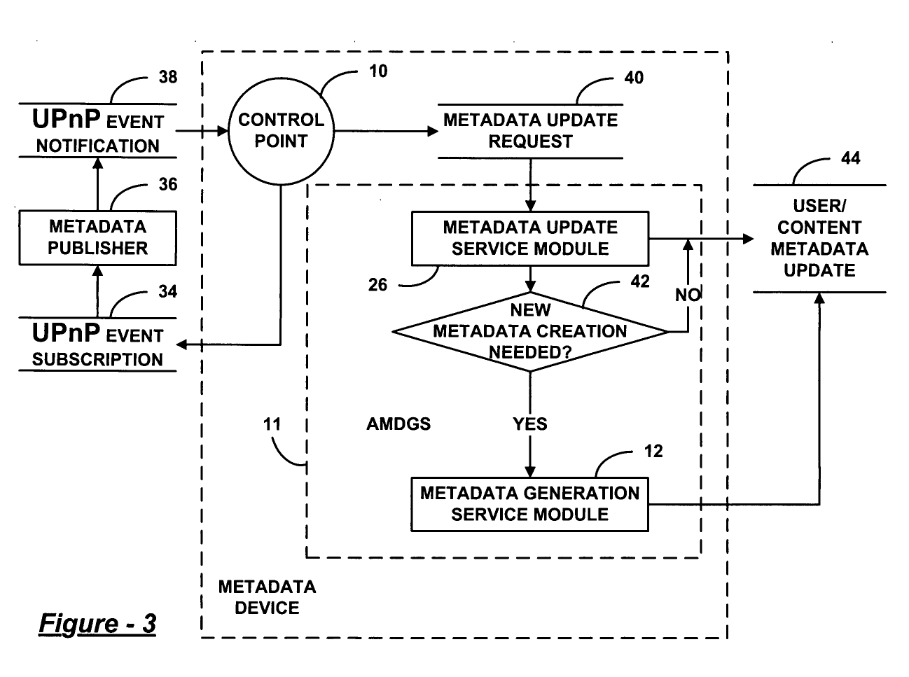

Turning now to FIG. 3 some embodiments of the AMDGS 11 can be a metadata generation service 12 employed by an update service 26 to generate metadata based on contents of an update request 40, generated by a control point as a result of subscription to a metadata publisher. For example, consider a control point 10 of a metadata device, such as a set top box or remote control, subscribing via subscribe message 34 to a media content stream-related metadata publisher that at least includes pre-authored metadata, such as “E-flyer” metadata in accordance with the TVA standard.

Control point 10, which is optional, can act as a monitoring module which may or may not generate metadata. In fact, control point 10 may, in generating request 40, transparently pass through metadata in whatever form it is received from the metadata publisher 36. Thus, metadata update request 40 can contain content metadata and/or pre-authored metadata that is not in a target metadata format (e.g., TVA format). Alternatively or additionally, control point 10 may generate user metadata based on its own A/V session control actions. Metadata generation service module and/or metadata update service module can translate the input metadata into the target metadata schema needed by the device. It should be readily understood that the control point is optional, as services can also interact with each other, by means of discovering each other, subscribing to each other, and invoking each other actions/interfaces.

In any case, update service module 26 can evaluate the metadata set to determine the need for generation of metadata at evaluation component 42, and form a metadata update message 44 of appropriate metadata. Any contents of update request 40 that are already in the proper form of metadata can be added to the action 44 directly. However, any AV action-generated metadata and/or pre-authored metadata not in the proper metadata format can be transmitted to metadata generation service 12. Metadata generation service 12 can then generate the metadata and return them to the update service 26 for addition to the message 44 carrying target metadata. This message 44 can then be transmitted over the communications system to accomplish metadata system update.

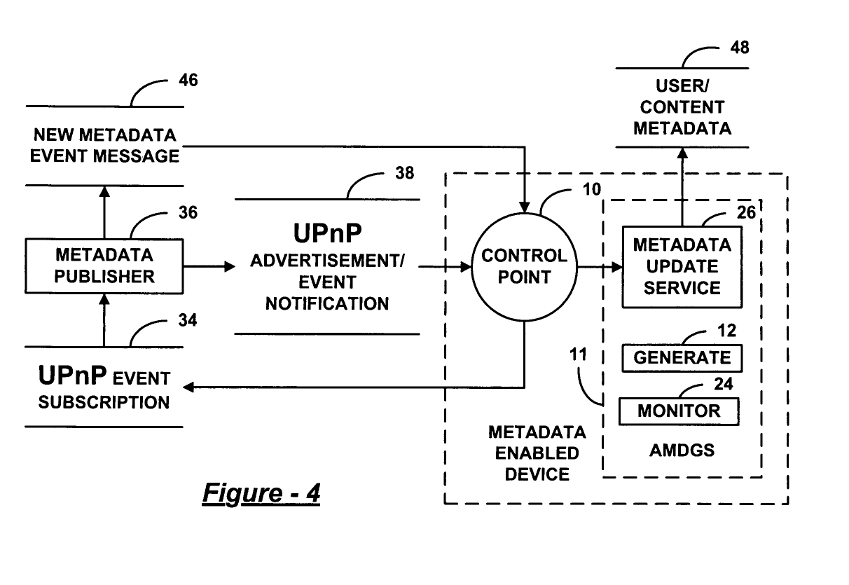

Turning now to FIG. 4, it should be readily understood that a metadata enabled device can have control point (CP) and services instances, and that the monitoring service module 24 of AMDGS 11 can translate interactions between other services (e.g., copies of AV actions) into instructions for the AMDGS 11. For example, in UPnP, CPs are separate entities from the services. Monitoring service module 24 can interpret the AV actions, and instruct MD update module 26 and/or generation module 12 accordingly. Also, monitoring service module 24 can subscribe to content providers and metadata publishers 36. For example, AMDGS 11 can subscribe to services of a metadata publisher 36 via messages 34 and 38, and thereafter receive new metadata event messages 46 that pass pre-authored metadata not already in the required metadata format to control point 10. In this manner, control point 10 can assist in connecting the AMDGS with other services so that metadata of the required format can be generated based on the pre-authored metadata, and passed to metadata update service 26. Update service 26 can therefore perform update using metadata 48 received from control point 10. However, it should be understood that the CP is optional, as services can subscribe to other services directly as described above. Also, UPnP events are just an example of service subscription events. Alternatives to UPnP event subscription can be metadata publisher service subscription. Further, any or all of monitoring service module 24, generation service module 12, or update service module 26 can receive the corresponding service events.

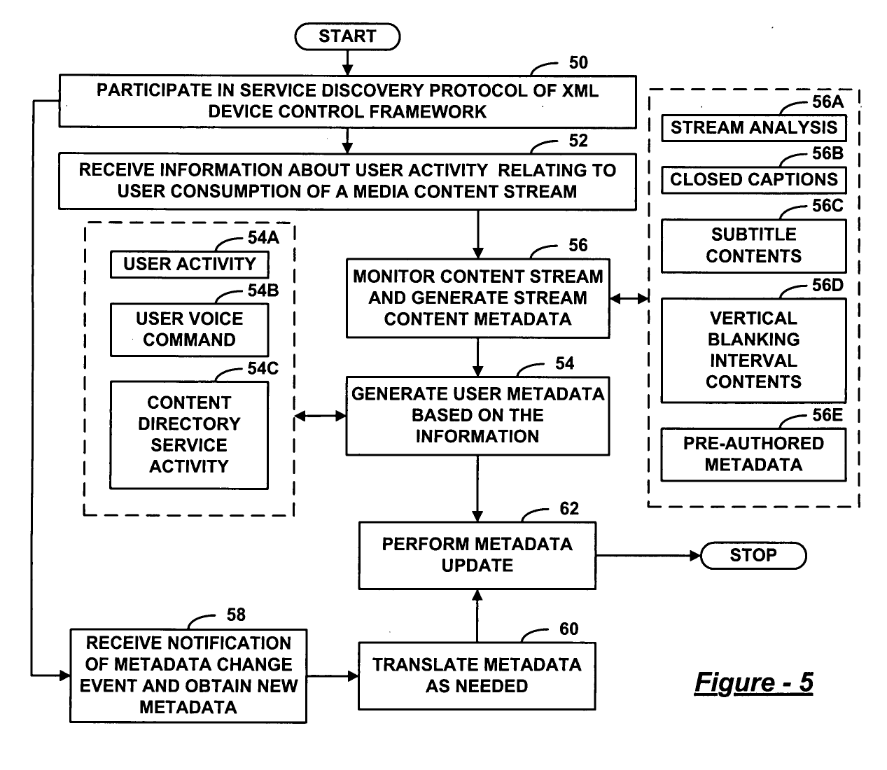

Turning now to FIG. 5, a method of operation for a TVA metadata generation system includes, in some embodiments, participating in a service discovery protocol of an XML device control framework at step 50. Information about user activity relating to user consumption of a media content stream can be received at step 52.

At step 54, user metadata can be generated based on received AV control actions. For example, user metadata can be generated based on user activity at step 54A, user voice command at step 54B, and/or content directory service (CDS) interactions with some control point at step 54C. Generating the user metadata based on user activity at step 54A can include generating user metadata based on user selections, user playback activity, and/or user rendering preferences. For example, user rendering preferences can be generated based on user playback activity.

At step 56, a media content stream can be received and monitored, with content metadata being generated based on characteristics and/or content of the stream. For example, content metadata can be generated based on stream analysis at step 56A that can include parsing contents of textual descriptions in an EPG, and/or noting stream segmentation by doing content stream picture analysys. Also, content metadata can be generated based on closed captions at step 56B, subtitle contents at step 56C, and any metadata included in the vertical blanking intervals at step 56D. Alternatively or additionally, in step 54 and/or step 56, any pre-authored metadata relating to user media consumption activity and/or media content that is not already in a required format can be used to generate equivalent metadata of the required format. For example, TVA metadata can be generated from non-TVA format metadata produced as user preferences and/or media consumption history. Also, non-TVA format metadata extracted from an EPG embedded in a media content stream can be converted to TV Anytime metadata as in step 56E. Other translations between metadata formats can also be made. The generated metadata can be used in an update at step 62.

In a parallel process, a notification can be received at step 58 of a metadata change event from a content or service provider, and the new metadata obtained. Then, the newly obtained metadata can be translated as described above to a required format as needed at step 60. Finally, an update can occur based on the metadata at step 62.

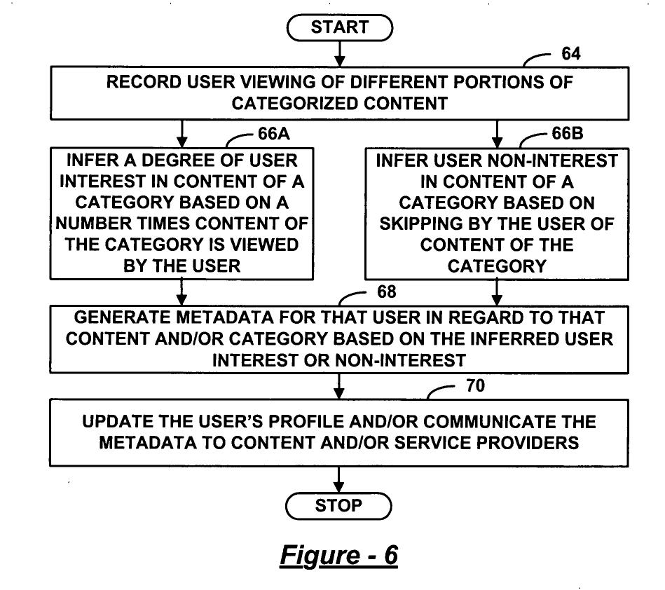

Turning now to FIG. 6, the process of generating user metadata based on user AV control commands/viewing activity is further explored with an example. For example, at step 64, recordings are made regarding user viewings of different portions of categorized content. For example, the user may skip a sports commercial, but view a particular car commercial twice. In this case, it is possible to infer a degree of user interest in automobiles or in the particular advertised automobile based on the number of times the user viewed the commercial at step 66A. Similarly, it is reasonable to infer that the user is not interested in sports in general, or perhaps not interested in the particular sport advertised at step 66B. User activity and other types of metadata can therefore be generated at step 68 about the user's interests. The user's profile (including metadata) can then be updated, and/or the content or service providers can be notified of the user's interest. Other home network users may also find it useful to view the user's profile in making gift purchase decisions, especially if instances of expressed user interest are tabulated with respect to categories, and the categories in the user's profile dynamically updated with metadata as they are observed. Such a user profile can be of similar use to content and service providers.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. An automatic metadata generation service system for use in home networks, the system comprising:
a home network interface adapted to perceive user network activity on a home network;
a metadata generation service module generating user metadata based on the user network activity;
an update service module automatically updating one or more existing metadata sets on the home network with generated metadata.

2. The system of claim 1, wherein said metadata generation service module generates user metadata based on user content viewing activity.

3. The system of claim 1, wherein said metadata generation service module generates content segmentation metadata based on user playback activity.

4. The system of claim 1, wherein said metadata generation service module generates user metadata based on user rendering preferences.

5. The system of claim 1, wherein said metadata generation service module generates user metadata based on control traffic corresponding to user voice command.

6. The system of claim 1, wherein said metadata generation service module generates user metadata based on content directory service (CDS) interaction with control points (CP).

7. The system of claim 1, further comprising a monitoring service module automatically performing an analysis of content and generating content metadata based on the analysis.

8. The system of claim 7, wherein said monitoring service module generates content metadata based on content stream segmentation.

9. The system of claim 7, wherein said monitoring service module generates content metadata based on parsed contents of textual descriptions contained in the content stream, wherein the descriptions describe media contents contained in the content stream.

10. The system of claim 7, wherein said monitoring service module generates content metadata based on closed captions contained in the content stream of stored content.

11. The system of claim 7, wherein said monitoring service module generates content metadata based on subtitles contained in the content stream.

12. The system of claim 7, wherein said monitoring service module generates content metadata based on predefined metadata contained in the content stream.

13. A metadata generation service system for use with a home network, comprising:
a home network interface adapted to interact with one or more of content providers or service providers according to one or more service discovery protocols;
a monitoring service module adapted to obtain an update of metadata from one or more of said providers; and
a metadata generation service module adapted to convert metadata of one format received via the update to metadata of another format required by the home network.

14. The system of claim 13, wherein said monitoring service module is adapted to subscribe to a control/metadata event change notification from one or more of said providers, consequently receiving said update.

15. The system of claim 13, further comprising an update service module adapted to update a set of metadata on the home network when the update becomes available.

16. The system of claim 15, wherein said update service module is adapted to communicate the metadata to one or more of said providers.

17. The system of claim 15, wherein said update service module is adapted to update user profiles related to users of the home network.

18. The system of claim 17, wherein said update service module updates a user profile of a user by recording a number of times the user consumed a particular portion of content.

19. The system of claim 17, wherein said update service module is adapted to dynamically update categories of content in the user profiles as new categories are revealed in the metadata.

20. The system of claim 13, wherein said metadata generation service module is further adapted to generate user metadata based on user network activity.

21. The system of claim 20, wherein said metadata generation service module generates user metadata based on user content viewing activity.

22. The system of claim 20, wherein said metadata generation service module generates content segmentation metadata based on user playback activity.

23. The system of claim 20, wherein said metadata generation service module generates user metadata and content metadata based on user rendering preferences.

24. The system of claim 20, wherein said metadata generation service module generates user metadata and content metadata based on control traffic corresponding to user voice command.

25. The system of claim 20, wherein said metadata generation service module generates user metadata and content metadata based on content directory service (CDS) interaction with control points (CP).
